(19) United States
(12) Patent Application Publication
(10) Pub. No.: US 2025/0346057 A1
(43) Pub. Date: Nov. 13, 2025

(54) PLANT-BASED POLYMERS FOR USE IN SUBSTRATES FOR BANKNOTES AND SECURE INSTRUMENTS

(71) Applicant: Spectra Systems Corporation, Providence, RI (US)

(72) Inventor: Nabil Lawandy, Saunderstown, RI (US)

(21) Appl. No.: 18/661,411

(22) Filed: May 10, 2024

(51) Int. Cl. B42D 25/29; B42D 25/351; B42D 25/36; C08J 5/18

(52) U.S. Cl. CPC B42D 25/29; B42D 25/36; C08J 5/18; B42D 25/351

(57) ABSTRACT

A banknote or secure instrument and associated methods of producing the banknote or secure instrument, the banknote or secure instrument including a substrate having a composition thereof, the substrate including a plant-based polymer material, the plant-based polymer material including polymerized monomers, where the polymerized monomers are based on a chemically refined plant matter output product.

### TECHNICAL FIELD

The present invention relates to processes for producing polymers, including polyolefins and polypropylene, from plant-based sources for use in substrates for banknotes and secure instruments. The present invention also relates to chemically converting plant-based source compounds to polymer materials acceptable for use in substrates for banknotes and secure instruments.

### BACKGROUND OF THE INVENTION

Banknotes have been made from a variety of materials over the centuries, such as leather during the Han Dynasty in China to shells, precious metals, cotton paper, and most recently plastic. These materials often reflect the social and political climate of the time as well as the available technologies and resources. For the past several centuries, paper has been the currency of choice around the world.

However, many countries are increasingly concerned about the environmental impact of their banknotes. As countries continue to adopt the Paris Climate Accords and strive to use more sustainable materials, the environmental impact of their currency as well as the associated durability and security of the currency are being considered. These considerations are causing many countries to use polymer banknotes. Polymer banknotes are made from a synthetic polymer, such as biaxially oriented polypropylene (BOPP). With recent technological developments, polymer banknotes offer additional security features, such as metameric inks, not available in paper banknotes. Polymer banknotes are also more energy efficient and last significantly longer than paper banknotes, resulting in a decrease in environmental impact and a reduced cost of production and replacement. Polymer banknotes are currently used in over 50 countries as diverse as Australia, Canada, Fiji, Mauritius, New Zealand, Papua New Guinea, Romania, Vietnam, and the United Kingdom.

Modern polymer banknotes were first developed by the Reserve Bank of Australia (RBA), Commonwealth Scientific and Industrial Research Organization (CSIRO), and the University of Melbourne. They were first issued as currency in Australia in 1988, and by 1996, the Australian dollar was switched completely to polymer banknotes. Romania was the first country in Europe to issue a plastic note in 1999 and became the third country after Australia and New Zealand to fully convert to polymer banknotes by 2003.

The Bank of Canada moved to polymer banknotes starting in 2011, after assessing the environmental impact of producing paper and plastic bills. A life-cycle assessment examined the effect, including primary energy demands and the potential for global warming, of each stage of production, such as from growing the cotton to producing the banknote paper or producing the raw material for polymer banknotes through the destruction and disposal of worn banknotes. In all categories and phases, polymer outperformed paper. Studies have shown that a polymer bill promises a 32 percent reduction in global warming potential and 30 percent reduction in primary energy demand compared with paper. Most importantly, polymer banknotes last more than twice as long as paper banknotes, which means fewer polymer banknotes have to be manufactured and distributed over the life of a series. Additionally, polymer banknotes weigh less than paper banknotes, which results in the benefit of transportation and distribution being more environmentally friendly. At the end of their life, paper bills are usually shredded and relegated to a landfill. Polymer banknotes, however, may be taken out of circulation, shredded, converted into pellets, and then used to make every day plastic items, such as lawn furniture.

The Bank of England spent three years studying the potential effect of a switch from cotton and linen paper banknotes and also concluded the superiority of plastic. A polymer £5 note featuring Sir Winston Churchill was launched in 2016, followed by a £10 Jane Austen note and a £20 note.

Currently, polypropylene and other polyolefins used to make polymer banknotes are primarily made from fossil fuels as starting materials. Propylene is one of the most essential petrochemical feedstocks and is used to make high-volume chemicals such as acrylonitrile, propylene oxide, and polypropylene films made either by a blown film process or on a tenter machine to produce BOPP used in polymer banknote substrates. The three-carbon monomer is produced mostly through naphtha cracking at petrochemical plants and fluid catalytic cracking in petroleum refineries. In both cases, fossil fuels are the main raw material.

Another source of starting material for polymer banknotes is chemically recycled plastics, as opposed to mechanically recycled plastics. Recycling of polymer banknotes has been performed primarily through mechanical recycling methods, resulting in recyclable waste usable in low performance polymer applications.

Additional efforts are underway to make polymer production more sustainable. One emerging technology is designed to make polymers from alcohol, particularly ethanol, derived from a variety of renewable or recyclable sources, including from plant matter. Ethanol has long been made from plants (e.g., corn, soy beans, palm oil, and sugarcane), and studies show that minute amounts of monomers such as propylene (also known as propene) naturally occur in many of these same plants. In recent years, researchers have worked to produce propylene, the monomer used to make polypropylene, from ethanol. One known process for propylene production from ethanol includes dehydrating ethanol to ethylene, dimerizing ethylene to 2-butene, and converting 2-butene to propylene through a metathesis reaction with ethylene. A single-step process for producing propylene ethanol is being researched in which ethanol is converted to propylene through various catalytic reactions, with some reactions reaching about 30% efficacy.

To reduce the carbon footprint of polymer-based banknotes in a manner which supports sustainability requires that polypropylene not be manufactured from fossil fuels, which cannot be regenerated. Accordingly, there is a need in the art for polymer-based banknotes to be made from sources that can be renewed to support the goals of both reduced environmental impact and increased sustainability.

### SUMMARY OF THE INVENTION

In general, in one aspect, the invention features a banknote or secure instrument, including a substrate having a composition thereof, the substrate including a plant-based polymer material, the plant-based polymer material including polymerized monomers, where the polymerized monomers are based on a chemically refined plant matter output product.

Implementations of the invention may include one or more of the following features. The polymerized monomers may be based on the chemically refined plant matter output product of at least one of rice, corn, soybean, palm oil, sugarcane, and combinations thereof. The substrate may be wholly comprised of the plant-based polymer material. The plant-based polymer material may be a polyolefin, and the polyolefin may be polyethylene, polypropylene, or combinations thereof. The plant-based polymer material may be polypropylene, and the substrate may be a biaxially oriented polypropylene (BOPP) substrate. The plant-based polymer material may be polyethylene.

The chemically refined plant matter output product may be ethanol. The polymerized monomers may include propylene. The plant-based polymer material may be obtained by a chemical conversion of ethanol monomers the into olefin and the polymerization of said olefin monomers. The ethanol may be distilled from fermented plant matter.

In general, in another aspect, the invention features a method for producing a banknote or secure instrument including a substrate having a composition thereof, the method including fermenting plant matter, distilling ethanol from the fermented plant matter, causing the ethanol to interact with at least one catalyst to generate a catalyzed chemical reaction, forming propylene through the catalyzed chemical reaction, performing a polymerization process on the propylene to form polypropylene, generating a plant-based polymer material including the polypropylene, and forming a substrate for a banknote or secure instrument, the substrate at least partially including the plant-based polymer material.

Implementations of the invention may include one or more of the following features. The substrate may be wholly comprised of the plant-based polymer material. The plant-based polymer material may be polypropylene, and the substrate may be a biaxially oriented polypropylene (BOPP) substrate. The method may further include printing visual data on the substrate.

In general, in another aspect, the invention features a method for producing a banknote or secure instrument including a substrate having a composition thereof, the method including fermenting plant matter, distilling ethanol from the fermented plant matter, dehydrating the ethanol to form ethylene, dimerizing the ethylene to form 2-butene, converting the 2-butene to form propylene through a metathesis reaction with ethylene, performing a polymerization process on the propylene and any other products of the metathesis reaction to form one or more polyolefins, generating a plant-based polymer material including the one or more polyolefins, and forming a substrate for a banknote or secure instrument, the substrate at least partially including the plant-based polymer material.

Implementations of the invention may include one or more of the following features. The substrate may be wholly comprised of the plant-based polymer material. The plant-based polymer material may be polypropylene, and the substrate may be a biaxially oriented polypropylene (BOPP) substrate. The one or more polyolefins may include polypropylene, polyethylene, or combinations thereof. The method may further include printing visual data on the substrate.

### BRIEF DESCRIPTION OF THE DRAWINGS

FIG. 1A shows a flowchart of an embodiment of a chemical process of the present invention capable of producing a plant-based polymer that may be employed as a substrate for secure instruments;

FIG. 1B shows a flowchart of another embodiment of a chemical process of the present invention capable of producting a plant-based polymer that may be employed as a substrate for secure instruments; and

FIG. 2 shows an embodiment of a banknote of the present invention.

### DETAILED DESCRIPTION OF THE INVENTION

The present invention is directed to the production of substrates for banknotes and secure instruments composed of plant-based polymer materials. In a preferred embodiment, a chemical reaction process is employed to convert plant-derived ethanol into polymer materials that are acceptable for use in secure instrument substrates. The secure instrument substrate may be the substrate for a banknote, a tax stamp, a credit card, a bank card, a license, or an identification document.

The present invention may utilize any known plant matter containing propylene or known to be convertible to ethanol, such as, for example, rice, corn, soybean, palm oil, and sugarcane. Accordingly, the plant-based polymer material may be composed of where the polymerized monomers (e. g., polymerized monomers, propylene or propene) are based on a chemically refined plant matter output product of, by, or from rice, corn, soybean, palm oil, sugarcane, and combinations thereof. Propylene from plant matter or propylene and other polyolefin monomers from the plant-derived ethanol may be utilized to form a plant-based polymer material capable of use as a banknote substrate. In a preferred embodiment, the plant-based polymer is a polyolefin, including but not limited to polyethylene or polypropylene. Polyolefins are inert, have low thermal conductivity, i. e., are excellent insulators, and are not subject to degredation by most chemicals. Additionally, as thermoplastic resins, most polyolefins can be recycled, either mechanically or chemically.

In a preferred embodiment, the plant-based polymer material is produced via a chemical process from plant-derived ethanol.

Such a chemical process may include fermenting plant matter, distilling ethanol from the fermented plant matter, dehydrating the ethanol to form ethylene, dimerizing the ethylene to form 2-butene, converting the 2-butene to form propylene through a metathesis reaction with ethylene, performing a polymerization process on the propylene and other products of the metathesis reaction to form polyolefins (including polypropylene, polyethylene, or combinations thereof), generating a plant-based polymer material comprising the polyolefins, and forming a substrate for a banknote, the substrate at least partly comprising the plant-based polymer material. In some embodiments, the substrate may be formed wholly from the plant-based polymer material.

In an alternate embodiment, the chemical process may include fermenting plant matter, distilling ethanol from the fermented plant matter, causing the plant-derived ethanol to interact with at least one catalyst to generate a catalyzed chemical reaction, forming propylene through the catalyzed chemical reaction, performing a polymerization process on the propylene to form polypropylene, generating a plant-based polymer material comprising the polypropylene, and forming a substrate for a banknote, the substrate at least partly comprising the plant-based polymer material. In some embodiments, the substrate may be formed wholly from the plant-based polymer material.

In either embodiment, further modification of the substrate may be performed to prepare the banknote or secure instrument. For example, visual data may be printed on the substrate in forming the banknote or secure instrument. The visual data may include images such as portraits, authentication information (such as serial numbers), or both.

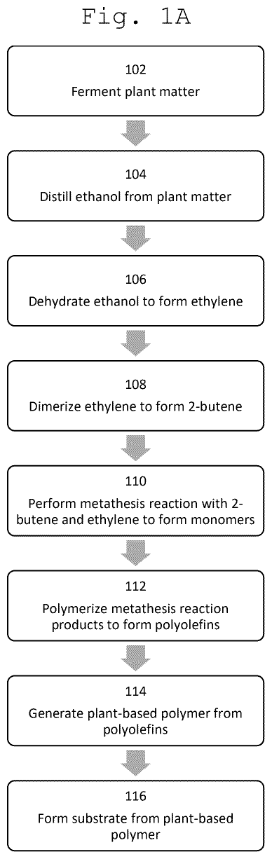

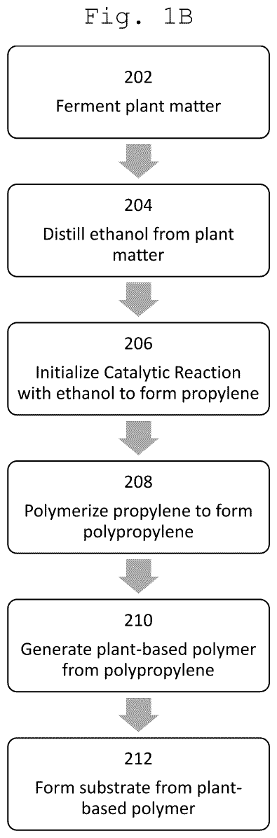

With reference now to the figures, FIG. 1A provides an embodiment of a chemical process of the present invention for the production of a plant-based polymer suitable for use as a substrate for secure instruments. In particular, plant matter is fermented (step 102), thereby producing ethanol. The ethanol is distilled from the fermented plant matter (step 104) and dehydrated to form ethylene (step 106). The ethylene may then be dimerized to form 2-butene (step 108), whereupon the 2-butene can be placed into metathesis reaction with ethylene to form monomers (step 110), such as propylene. The products of the metathesis reaction, namely propylene and ethylene, may be subjected to a polymerization process to form polyolefins (step 112), including polypropylene, polyethylene, or combinations thereof. The polyolefins are formed into a plant-based polymer material (step 114), whereupon the plant-based polymer material may then be used to at least partially form a substrate for a secure instrument (step 116), such as a banknote.

Referring to FIG. 1B, an alternate embodiment of a chemical process of the present invention for the production of a plant-suitable for use as a substrate for secure based polymer instruments is shown. In particular, plant matter is fermented (step 202), thereby producing ethanol. The ethanol is distilled from the fermented plant matter (step 204), whereupon the ethanol may be caused to interact with at least one catalyst to induce a catalytic reaction that forms propylene (step 206). The propylene may then be subjected to a polymerization process to form polypropylene (step 208). The polypropylene is formed into a plant-based polymer material (step 210), whereupon the plant-based polymer material may then be used to at least partially form a substrate for a secure instrument (step 212), such as a banknote.

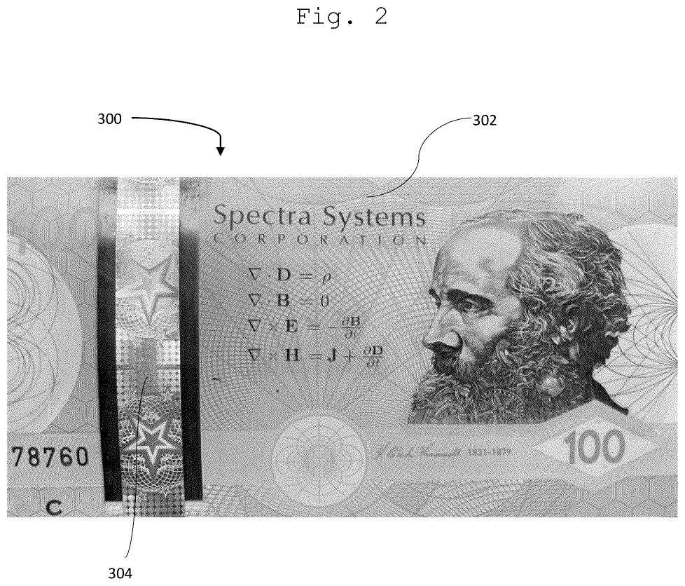

With reference to FIG. 2, an embodiment of a banknote 300 of the present invention is shown. The banknote 300 is formed of a substrate 302 with at least a portion of the substrate 302 (e.g., the clear window portion) formed of a plant-based polymer 304, in accordance with the present invention.

A substrate 302 for secure instruments of the present invention, such as for a hybrid polymer banknote 300, may contain a certain amount (e.g., 20% or more up to 100%) of the plant-based polymer material 304, whether the plant-based polymer material 304 is formed directly from plant matter or from ethanol derived from plant matter. In a specific example, a substrate 302 for secure instruments of the present invention may contain a certain amount (e.g., 25% or more up to 100%) of the plant-based polypropylene along with additional polymers to produce biaxially oriented polypropylene (BOPP), such as for banknotes and other financial instruments including credit cards.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

1. A banknote or secure instrument, comprising:
a substrate having a composition thereof and a clear window portion, the substrate consisting of:
a plant-based polymer material, the plant-based polymer material comprising polymerized monomers,
wherein the polymerized monomers are based on a chemically refined plant matter output product, and
wherein the clear window portion consists of the plant-based polymer material.

2. The banknote or secure instrument of claim 1, wherein the polymerized monomers are based on the chemically refined plant matter output product of at least one of rice, corn, soybean, palm oil, sugarcane, and combinations thereof.

3. (canceled)

4. The banknote or secure instrument of claim 1, wherein the plant-based polymer material is a polyolefin.

5. The banknote or secure instrument of claim 4, wherein the polyolefin is polyethylene, polypropylene, or combinations thereof.

6. A banknote or secure instrument, comprising:
a substrate having a composition thereof, the substrate consisting of:
a plant-based polymer material, the plant-based polymer material comprising polymerized monomers,
wherein the polymerized monomers are based on a chemically refined plant matter output product
wherein the plant-based polymer material is polypropylene, and
wherein the substrate comprises a biaxially oriented polypropylene (BOPP) substrate.

7. The banknote or secure instrument of claim 1, wherein the plant-based polymer material is polyethylene.

8. The banknote or secure instrument of claim 1, wherein the chemically refined plant matter output product is ethanol.

9. The banknote or secure instrument of claim 8, wherein the polymerized monomers comprise propylene.

10. The banknote or secure instrument of claim 8, wherein the plant-based polymer material is obtained by a chemical conversion of the ethanol into olefin monomers and the polymerization of said olefin monomers.

11. The banknote or secure instrument of claim 10, wherein the ethanol is distilled from fermented plant matter.

12-20. (canceled)
